(19) United States
(12) Patent Application Publication
(10) Pub. No.: US 2007/0014710 A1
(43) Pub. Date: Jan. 18, 2007

(54) Catalyst for removing pollutants from exhaust gases from lean-burn engines, with ruthenium as active metal

(76) Inventors: Olga Gerlach, Ludwigshafen (DE); Wolfgang Strehlau, Dossenheim (DE); Jürgen Maier, Mannheim (DE)

Correspondence Address: STEPHEN D. SCANLON, JONES DAY, 901 LAKESIDE AVENUE, CLEVELAND, OH, 44114, US

(21) Appl. No.: 10/570,221

(22) PCT Filed: Sep. 1, 2004
(86) PCT No.: PCT/EP04/09739

§ 371 Date: Mar. 10, 2006

(30) Foreign Application Priority Data
Sep. 3, 2003 (DE) 10340653.0

(51) Int. Cl. B01D 53/94

(52) U.S. Cl. 423/213.5; 502/304

(57) ABSTRACT

The invention relates to a catalyst for exhaust-gas purification in lean-burn engines, the catalyst comprising at least ZrO₂ and/or Ce/Zr mixed oxide as support material and ruthenium as active metal, on its own or together with at least one further active metal selected from the precious metals group. Rare earth oxides and transition metals are used as promoters. The invention also comprises a method for purifying the exhaust gas from lean-burn engines in rich/lean and constant lean mode, in which a catalyst as defined above is used.

The present invention relates to a novel catalyst for removing pollutants from the exhaust gases from lean-burn engines, which as support material comprises ZrO₂ and/or Ce/Zr mixed oxide and as active metal comprises ruthenium, alone or in combination with at least one further active metal from the precious metals group. Furthermore, the catalyst may include rare earth oxides as promoters, and further transition metals or transition metal compounds, the transition metals being different from rare earth oxides and precious metals, as co-promotors. Furthermore, the present invention relates to a method for purifying exhaust gases from lean-burn engines in rich/lean and constant lean mode using the catalyst according to the invention.

The catalyst according to the invention ensures the conversion of the nitrogen oxides (NOₓ) in the lean-burn engine exhaust gas in rich/lean mode in the temperature range between 200 and 500° C. and has a lower light-off temperature for the conversion of carbon monoxide (CO) and hydrocarbons (HC). The catalyst is highly thermally stable and deteriorates only slightly after thermal ageing at 700° C. in air. It therefore has a high activity and thermal stability.

The main pollutants from the exhaust gas from lean-burn engines are carbon monoxide (CO), unburnt hydrocarbons (HC)—paraffins, olefins, aldehydes, aromatics—and nitrogen oxides (NOₓ), sulphur dioxide (SO₂), and also, in the case of diesel engines, particulates, which contain the carbon both as a solid and in the form of what is known as the “volatile organic fraction” (VOF). Depending on the operating point, the oxygen concentration in the diesel exhaust gas is mainly between 1.5 and 10%.

Compared to exhaust gases from petrol engines, diesel exhaust gases are at significantly lower exhaust-gas temperatures. For part-load operation, the exhaust-gas temperatures upstream of the catalyst are in the range between 120 and 300° C., and the maximum temperatures in full-load operation reach 550 to 650° C. In particular for the purification of diesel exhaust gases from passenger cars, a high low-temperature activity is required of the oxidation and deNOx catalysts; on the other hand, they have to be highly thermally stable, in order to avoid a loss of activity at high temperatures, such as for example those which occur at full-load operation.

Currently, diesel passenger cars and lorries, although the latter only to a lesser extent, are equipped with precious metal-containing oxidation catalysts which are able to convert CO and HC, and also to a very slight extent particulates, into CO₂ and water. The NOₓ emissions are scarcely abated, on account of the high excess of oxygen in the exhaust gas.

Despite the large number of existing solution approaches, many problems still remain and are of particular significance in the specialist field; for example, in particular the problem of improving the resistance of catalysts to ageing and their resistance to deactivation by sulphur compounds, which is dealt with in the present invention. This applies in particular to catalysts which are used for exhaust-gas purification in fuel engines in the non-stoichiometric range. An operating procedure of this nature is used as the basis, for example, for engines which are preferably run in lean-burn mode, i.e. with an excess of oxygen, and which are regarded as a type of engine holding particular promise for the future.

For a very general overview of NOₓ catalysis, including references to the most common forms of exhaust gas catalysts and the relevant prior art in connection with NOₓ storage catalysts, reference should be made to DE 102 09 529.9, in the name of the present Applicant, and the prior art cited therein. That document also deals in depth with the problems of exhaust-gas catalysts of this type.

DE 198 36 249 relates to a method for breaking down nitrogen oxides in the exhaust gas from a combustion device, in which the combustion device is alternately operated in lean and rich operating phases, which is characterized in that in the lean operating phases the nitrogen oxides are broken down by means of a direct catalytic splitting reaction which is material-catalyzed by a splitting catalyst which is regenerated during the rich operating phases. The only indication as to the composition of the catalyst that can be used with success as part of a method of this type is that the splitting catalyst material used therein contains bismuth.

EP 0 722 763 relates to an adsorption agent for NOx, in which the oxides of Ru and/or Ce used as adsorbing components are applied to a titanium oxide support material. The titanium oxide support material is obtained by adding a manganese compound to amorphous titanium dioxide, and then heating the latter.

DE 10036886 describes an NOx storage catalyst which is free of alkali metals and rare earths, contains rhodium or a mixture of platinum and rhodium as active component(s) and has a very good low-temperature activity in the fresh state. No details are given as to the durability of the catalyst.

EP 1 036 591 describes an NOₓ storage catalyst which contains at least one element selected from the group consisting of alkaline-earth metals, alkali metals or rare earths and at least one precious metal, Pt, on a first support material. Rh is deposited on zirconium oxide as second support material. It is explained that the Rh/ZrO₂ has a high activity for the water/steam reforming and protects the catalyst from SOX poisoning.

EP 1 010 454 describes a storage catalyst which contains a zirconium oxide/alkali metal oxide composite and at least one precious metal selected from Pt, Pd, Rh.

WO 02/22255 presents NOₓ catalysts which contain at least one precious metal selected from rhodium and palladium and/or mixtures thereof, zirconium oxide and either cerium oxide, praseodymium oxide, neodymium oxide or mixtures thereof. The catalysts may have layer structures, with the upper layer being composed mainly of the abovementioned elements and the lower layer including a support oxide consisting of aluminium oxide, silicon oxide, silicon/aluminium oxide, zeolite or mixtures thereof, as well as platinum, palladium, rhodium or mixtures thereof.

In view of the prior art, the object of the invention is to provide a novel three-way catalyst which can be used in a method for purifying the exhaust gases from internal combustion engines which are at least in part operated in lean-burn mode. The intention is to ensure that in particular the decrease in NOₓ activity which occurs during the thermal ageing of NOₓ storage catalysts of the prior art is minimized, and that the efficiency of the catalysts described in the prior art is further increased.

The object according to the invention is achieved by the provision of a novel catalyst for exhaust-gas purification in lean-burn engines, the catalyst comprising at least the following components (i) and (ii):
(i) ZrO₂ and/or Ce/Zr mixed oxide as support material, and
(ii) ruthenium as active metal, on its own or together with at least one further active metal, selected from the precious metals group.

Furthermore, the present invention relates to a method for purifying the exhaust gas from lean-burn engines operated in lean/rich and constant lean mode, with a catalyst according to the present invention being used in this method.

The following text is intended to define relevant terms which are of importance to understanding and interpreting the present invention.

In the context of the present invention, the generic terms “alkali metal oxides”, “alkaline-earth metal oxides” and “rare earth oxides” encompass in a very general way not only the stoichiometric oxides, but also the corresponding carbonates, hydroxides, suboxides, mixed oxides and any desired mixtures of at least two of the abovementioned substances. The term “NOₓ storage materials” is accordingly to be understood as meaning alkali metal oxides and/or alkaline-earth metal oxides in accordance with the definition which has just been given. Accordingly, the term “transition metals” is also to be understood as encompassing the corresponding oxides and suboxides. Furthermore, all the (precious) metals mentioned as elements also encompass the corresponding oxides and suboxides. In the context of the present invention, the term “precious metals” encompasses the elements gold, silver, rhenium and also what are known as the platinum metals, i.e. rhodium, palladium, osmium, iridium and platinum, as well as the corresponding oxides and suboxides thereof.

Combustion engines are thermal energy converters which transform chemical energy stored in fuels into heat by combustion and ultimately into mechanical energy. For internal combustion engines, the air enclosed in a gastight and variable working space (e.g. a cylinder) is the working medium defined in the sense of a heat engine and is at the same time the carrier of the oxygen required for the combustion. The combustion is carried out cyclically, with both the fuel and the (atmospheric) oxygen being freshly charged before each cycle. Depending on the cycle used, for example described by a Carnot pV diagram, it is possible to draw an exact thermodynamic distinction between a spark-ignition engine and a diesel engine. A practical working definition of these types of engine is given below.

A significant criterion for classifying both types of engine and catalysts is the petrol to air ratio, expressed by means of the “air/fuel ratio” λ. In this context, a value of λ=1.0 corresponds precisely to the stoichiometric ratio of petrol to dry air, i.e. there is just enough air in the combustion chamber for it to be possible for all the petrol to be burnt stoichiometrically to form carbon dioxide and water.

The specialist technical literature refers to mixtures with λ>1 as “lean” (excess oxygen) and those with λ<1 as “rich” (lack of oxygen). In the context of the present invention, mixtures with λ>1.2 are to be referred to as “lean” and mixtures with λ<1.0 are to be referred to as “rich”, in order to provide a clear demarcation from the stoichiometric range. Accordingly, the rich and/or lean mixtures defined in this way are also referred to as non-stoichiometric mixtures in the context of the present invention.

Conventional spark-ignition engines are characterized by the formation of a homogeneous petrol/air mixture outside the working space, i.e. the piston space, in which the combustion takes place, and by controlled externally generated ignition. Spark-ignition engines require low-boiling fuels which are not readily ignitable (the ignition limits for a spark-ignition engine are typically between λ=0.6 and λ=1.4). In the context of the present invention, it is of particular importance with regard to exhaust-gas catalysis that conventional spark-ignition engines which have a three-way catalyst controlled by λ sensor are predominantly operated at a λ value of approximately 1 (=stoichiometric operation).

The term “lean-burn engines” is to be understood as meaning spark-ignition engines which are operated mainly with an excess of oxygen. For the purposes of the present invention, lean-burn engines are defined very specifically on the basis of their λ value, i.e. lean-burn engines in the context of the present invention are engines which, even apart from overrun cutoffs, are at least in part operated in the lean state, i.e. at a λ value of 1.2 or above. In addition, rich operating states may, of course, also occur in lean-burn engines: brief richer running of the engine and therefore also of the exhaust gases can be initiated by the engine electronics with the aid of modern injection systems or can also occur in natural driving operation (e.g. in the event of increased loads, at full load or when starting up). An alternating operating mode comprising rich and lean cycles is referred to in the context of the present invention as “rich-lean mode”.

In particular, lean-burn engines in the context of the invention are to be understood in very general terms as encompassing the following embodiments:
all spark-ignition engines with direct injection (DI engines) and with operating states of λ>1, and all spark-ignition engines with external mixture formation. This class includes, inter alia, stratified charge engines, i.e. engines which have an ignitable mixture in the vicinity of the spark plug but otherwise an overall lean mixture, and also spark-ignition engines with higher compression in conjunction with direct injection. This includes, for example, engines operating using the Mitsubishi method (GDI=gasoline direct injection; common rail injection), the FSI (=fuel stratified injection) engine developed by VW or the IDE (=injection directe essence) engine designed by Renault;
all diesel engines (see below);
multifuel engines, i.e. engines which burn fuels and fuel mixtures which are readily ignitable and/or not readily ignitable, such as alcohols, bio-alcohols, vegetable oils, kerosene, petrol and any desired mixtures of two or more of the abovementioned substances.

Diesel engines are characterized by internal mixture formation, a heterogeneous fuel/air mixture and by compression ignition. Accordingly, diesel engines require readily ignitable fuels. In the context of the present invention, it is particularly important that diesel exhaust gases have similar characteristics to the exhaust gases from lean-burn engines, i.e. are continuously lean, that is to say oxygen-rich. Consequently, the demands imposed on the catalysts for NOₓ reduction in combination with diesel engines, with regard to the elimination of nitrogen oxides, are similar to those imposed on catalysts used for spark-ignition engines in lean-burn mode. One significant difference between diesel passenger car engines and spark-ignition passenger car engines, however, is the generally lower exhaust-gas temperatures of diesel passenger car engines (100° C. to 350° C.) compared to spark-ignition passenger car engines (250° C. to 650° C.) which occur during the legally prescribed driving cycles. A lower exhaust-gas temperature makes the use of catalysts which are not contaminated with sulphates or are only slightly contaminated with sulphates particularly attractive, since desulphurization, as mentioned above, is only effectively possible at exhaust-gas temperatures above approximately 600° C. All the statements which have been made in the present invention with regard to catalysts for lean-burn engines therefore also apply in a corresponding way to catalysts which are used for diesel engines.

Depending on the mixture formation and the load/engine speed characteristic diagram, catalysts which are specifically matched to different engines are required for exhaust-gas treatment. For example, a catalyst for a conventional spark-ignition engine, the petrol/air mixture of which is continuously set to λ≈1 with the aid of injection and throttle valve and whose air/fuel ratio is optionally monitored with the aid of a λ sensor requires altogether different functionalities for the reduction of NOₓ from, for example, a catalyst for a lean-burn engine which is operated at λ>1.2, i.e. has excess oxygen during normal driving operation. It is clear that catalytic reduction of NOₓ at an active metal is more difficult if there is an excess of oxygen.

The term “three-way catalyst”, as used in the context of the present invention, relates in very general terms to catalysts which remove three main pollutants from the exhaust gas of internal combustion engines, namely nitrogen oxides (NOₓ) by reduction to form nitrogen, carbon monoxide by oxidation to form carbon dioxide and hydrocarbons by oxidation to form, ideally, water and carbon dioxide. If a catalyst is used in diesel engines, a fourth object may occur in addition to the three mentioned above, namely the removal of particulates by oxidation.

Conventional three-way catalysts for spark-ignition engines according to the prior art are used in stoichiometric mode, i.e. at λ values which fluctuate within a narrow range around 1.0. The λ value is in this case set by regulating the petrol/air mixture in the combustion chamber with the aid of injectors and throttle valve. In non-stoichiometric operation, i.e. in non-conventional operation, it is possible for λ values to deviate significantly from 1.0, for example λ>1.2 or λ>2.0, or alternatively λ<0.9. The discontinuous operation of an engine, i.e. alternating operation between lean and rich operating modes of the engine, is referred to as rich-lean operation.

One particular embodiment of a three-way catalyst which can also be operated in non-stoichiometric mode, in particular when lean operating states occur, is the NOₓ storage catalyst. In the context of the present invention, an NOₓ storage catalyst is to be understood as meaning a three-way catalyst which can operate in rich-lean mode and the composition of which means that the nitrogen oxides NOₓ, during lean-burn mode, are stored in a storage medium, typically a basic alkali metal oxide or alkaline-earth metal oxide, and the actual decomposition of the stored nitrogen oxides to form nitrogen and oxygen only takes place during a richer phase under reducing exhaust-gas conditions.

The method described in the present invention and the catalyst according to the invention are designed for long-term use for exhaust-gas treatment in motor vehicles in a practical way. Accordingly, in the context of the present invention, the term “normal driving operation” is to be understood as meaning all exhaust-gas compositions and temperatures which are typical for operating points of an engine during the NEDC (new European driving cycle). In particular, starting of the engine, warming up and operation under extreme loads are not regarded as normal driving operation.

The catalyst according to the invention comprises ZrO₂ as support material. According to the invention, the support material used may be any form of zirconium oxide which is porous and is able to withstand the maximum temperatures which occur during operation of the catalyst for the operating time which is normal for the removal of pollutants from motor vehicle exhaust gases. Therefore, the term “ZrO₂” as used in accordance with the invention encompasses in particular the refractory, i.e. non-decomposable, oxides of zirconium, as well as associated mixed oxides and/or oxide mixtures.

The further active metal is selected from the precious metals group, with ruthenium of course being ruled out in this context. It is preferable for the at least one further active metal to be selected from Pt, Rh, Pd, Ir; of course, it is also possible to use two or more of these further active metals.

In the context of the present invention, in terms of the mass ratio of Ru to the sum of all further active metals, based on the elements, it is in principle conceivable to use any value which leads to the catalyst according to the invention, in rich-lean mode, having a better activity than the catalysts of the prior art. In this context, the higher the Ru content, the greater the catalytic activity becomes. When selecting the optimum ratio of ruthenium to further active metals, costs of course also play a role, in which context it should be noted that, for example, precious metals such as for example Rh and Pt are relatively expensive compared to Ru. In the context of the present invention, a mass ratio of Ru to the sum of all further active metals of at least 1:99 is preferred. A ratio of at least 5:95 is more preferred and a ratio of at least 1:9 is particularly preferred.

With regard to the weight ratio of active metal, i.e. the sum of Ru and all further active metals used, to the support material, it is the case that a proportion of 0.01% by weight to 5% by weight of active metal, based on the total weight of active metal and support material is preferred, and a proportion by weight of from 0.1% by weight to 3% by weight is particularly preferred. With regard to the proportion of Ru alone used relative to the porous support material on which it is fixed, a value of between 0.01% by weight and 5% by weight is preferred, with a value in the range from 0.05% by weight to 0.2% by weight being particularly preferred.

In the context of the present invention, the active metal described above will preferably be doped with at least one rare earth oxide as promoter, since in the context of the present invention it has surprisingly been discovered that the thermal durability of the Ru-containing catalyst, i.e. its activity after thermal ageing, can be increased by additional doping with at least one rare earth oxide.

The at least one rare earth oxide is preferably selected from the following group consisting of La oxide, Ce oxide, Pr oxide, Nd oxide, Sm oxide, Eu oxide, Gd oxide, Tb oxide, Dy oxide, Ho oxide, Er oxide, Tm oxide, Yb oxide, Lu oxide, as well as mixtures of at least two of the abovementioned oxides, with Ce oxide being particularly preferred.

With regard to the weight ratio of rare earth oxide to ZrO₂, in principle it is possible to use any value in the range from 0.1% by weight to 50% by weight for the rare earth oxide, but a proportion of rare earth oxides relative to the total quantity of ZrO₂ in the range from 2% by weight to 30% by weight is preferred.

Furthermore, the catalyst according to the invention may comprise at least one further transition metal or a further transition metal compound as co-promoter, this transition metal of course being different from rare earths and precious metals. In this context, the metals Fe, Cr, Ni, Cu, W, Sn, Nb and Ta are particularly preferred. The mass ratio of the sum of the active metals to the co-promoters is preferably 1:1, more preferably 1:5. According to the invention, it is particularly preferable for the ruthenium and, if present, the rare earth oxide to be jointly present on the ZrO₂. The same applies if the transition metal/transition metal compound components used as co-promoters are present, and also with regard to the further active metal.

In addition to the required components of the catalyst according to the invention described above, all conceivable auxiliaries or additives can be used for production or further processing of the catalyst, such as for example Ce/Zr mixed oxides as additives to the support material, binders, fillers, hydrocarbon adsorbers or other adsorbing materials, dopants for increasing the thermal stability and mixtures of at least two of the abovementioned substances.

The activity of the catalysts is also dependent in particular on the macroscopic form and morphology of the catalyst. With regard to the form of the catalyst, all embodiments which have already proven suitable in very general terms in catalyst research, i.e. in particular washcoat and/or honeycomb technologies, are preferred.

The abovementioned technologies are based on the majority of the support material being milled in aqueous suspension to particle sizes of a few micrometres and then being applied to a ceramic or metallic shaped body. In principle, further components in water-soluble or water-insoluble form can be introduced into the washcoat before or after the coating operation. After all the constituents of the catalyst have been applied to the shaped body, the latter is generally dried and calcined at elevated temperatures.

It is particularly preferable to use arrangements of the support material with a high BET surface area and a high retention of the BET surface area after thermal ageing. With regard to the pore structure, it is particularly preferable to use macropores which have been formed into channels and coexist with mesopores and/or micropores. In this case, the mesopores and/or micropores contain the actual catalytically active material, in this case Ru and the further active metal. Furthermore, in the context of the present invention, it is particularly preferred that (i) active metals and promoter be jointly present in immediate topographical proximity, and that (ii) active metals and promoter as a unit be distributed as homogeneously as possible within the porous support material.

A zirconium oxide which is preferably used is a zirconium oxide of which more than 80% corresponds to the monoclinic phase.

It is particularly preferable to use a ZrO₂ marketed by Norton under designation “XZ 16075”. In principle, the ZrO₂ can be produced using precipitation processes with which the person skilled in the art will be familiar. In particular, steam calcining of the material precipitated in this way leads to Zr oxides which are preferred in the context of the invention. Alternatively, it is also possible for Ce/Zr mixed oxide to be used as support oxide for the ruthenium. The preferred mass ratio of CeO₂ to ZrO₂ is in this case 1:1, more preferably 1:5, even more preferably 1:10. Of course, it is also possible for a mixture of ZrO₂ and Ce/Zr mixed oxide to be used as support for the ruthenium, in which case there are no specific limits with regard to the mass ratio of the two support oxides relative to one another.

In addition to the components which have been extensively discussed above, the catalyst preferably also comprises a NOx storage component; in this context, it is possible to use all storage components which are known from the prior art. In particular, the storage component is selected from the group consisting of oxides or carbonates of Ba, Sr, La, Pr or Nd, which are each applied to a porous support oxide. The support oxides used may be oxides which are known from the prior art, such as Al₂O₃, SiO₂, Al₂O₃/SiO₂ mixed oxide, TiO₂, CeO₂ or CeO₂/ZrO₂ mixed oxide, with CeO₂ and CeO₂/ZrO₂ mixed oxides being particularly preferred.

For many applications, it will be expedient for some of the at least one further active metal to be fixed together with Ru on the ZrO₂ and for a further part of the further active metal to be deposited separately from the Ru on another support oxide or even the same support oxide, since this allows deliberate setting of the further functionalities of the catalyst, such as its ability to oxidize carbon monoxide and hydrocarbons.

In principle, any method known to the person skilled in the art for the production of catalysts, in particular impregnated and surface-impregnated catalysts, can be used to homogeneously disperse the catalytically active substances, i.e. in particular to homogeneously disperse active metals and rare earth oxides. In this context, mention should be made, for example, of the following methods, some of which are also described in the exemplary embodiments: impregnation of the support materials with metal salt solutions, adsorption of metal salts from gases or liquids on the support materials, application by precipitation from solutions, formation of layers and/or double layers, introduction of colloids, gels, nanoparticles, spraying or deposition from solutions. The catalyst according to the invention is preferably in the form of powder, granules, extrudate, a shaped body or a coated honeycomb body.

As has been mentioned in the introduction, the present invention also relates to a method for purifying exhaust gases from lean-burn engines in rich-lean and constant lean mode, in each case using at least one catalyst as described above.

The method according to the invention for converting/detoxifying the exhaust gases from a lean-burn engine using the principle of a three-way catalyst as defined above consists in the above-described catalyst according to the invention being operated in a rich-lean cycle. The time windows of the said rich-lean cycle are selected in such a way that the nitrogen oxide emissions through the catalyst are lowered by the catalyst during the lean-burn phase, and the catalyst is regenerated by briefly using richer conditions.

The said time window is given by two parameters, namely the duration of the lean phase and the ratio of lean phase to rich phase. In general, any choice of parameters which leads to sufficient integral nitrogen oxide conversion is permissible. The duration of the lean phase depends largely on the concentrations of the oxygen and the nitrogen oxides in the exhaust gas and on the total volumetric flow of the exhaust gas and the temperature at the catalyst. The duration of the rich phase is determined by the factors air/fuel ratio λ, the concentrations of H₂, CO in the exhaust gas and the total volumetric flow. A value of greater than 5:1 is preferred for the ratio of lean phase to rich phase, with a value of greater than 10:1 being more preferred and a value of greater than 15:1 being particularly preferred. Any desired duration is conceivable for the duration of the lean phase, and for practical applications in normal driving mode a time window of from 5 to 240 seconds, in each case inclusive, is preferred, and a time window of from 10 to 80 seconds duration is particularly preferred.

In this context, it should also be noted that the method according to the invention, like any method for the regulated catalysis of exhaust gases, is or can be regulated not only by sensors and control codes, but also is influenced by the way in which the vehicle is driven. For example, “natural” richer operation occurs if the engine is accelerated to high revs and/or suddenly and/or is operated under high loads. In operating states of this type, driving operation can, for example, be temporarily switched over to non-lean operation with λ=1 or λ<1, or alternatively it is possible for the rich phase, for a short period of time, to last longer than in normal, regulated operation, or for the rich phase to be favoured for operational reasons.

In one preferred embodiment, an NOₓ sensor is used to control the rich/lean cycle, and a richer phase is in each case induced precisely when a predetermined NOₓ limit value is reached.

With regard to the use of the catalyst according to the invention, it should be noted that it is preferable for the catalyst to be installed in a position close to the engine or to be installed in an underfloor position. The catalyst according to the invention may also be operated in combination with at least one further catalyst or filter selected from the following group: conventional starting or light-off catalysts, HC-SCR catalysts, NOₓ storage catalysts, λ-regulated three-way catalysts, soot or particulate filters. In this context, by way of example, the soot particulate filter may be coated with the catalyst according to the invention. It is conceivable for the catalyst according to the invention to be combined with the abovementioned catalysts (i) by sequential arrangement of the various catalysts, (ii) by physical mixing of the various catalysts and application to a common shaped body, or (iii) by application of the various catalysts in the form of layers to a common shaped body, and of course in any desired combination of the above.

It is preferable for the method according to the invention to be carried out in such a manner that the exhaust-gas purification comprises the simultaneous oxidation of hydrocarbons and carbon monoxide and the reduction of nitrogen oxides, and also, optionally, in the case of diesel engines, the removal of particulates.

Furthermore, it should also be noted that the catalyst according to the invention can be used in virtually all conceivable lean-burn engines, in which context spark-ignition engines with direct petrol injection, hybrid engines, diesel engines, multi-fuel engines, stratified charge engines and spark-ignition engines with unthrottled part-load operation and higher compression or with unthrottled part-load operation or higher compression, each with direct injection, are preferred.

A preferred operating mode is also defined by the rich/lean operation being regulated using an NOₓ sensor, which is preferably fitted downstream of the final exhaust-gas catalyst, with richer operation being induced when an adjustable NOₓ threshold value is exceeded.

The production of examples of catalysts according to the invention, as well as their improved properties compared to the prior art, are to be illustrated and explained below in exemplary embodiments. The fact that this is done using specific examples giving specific numerical values should not in any way be regarded as restricting the general details given in the description and the claims.

### EXAMPLES

### Example 1 (E1)

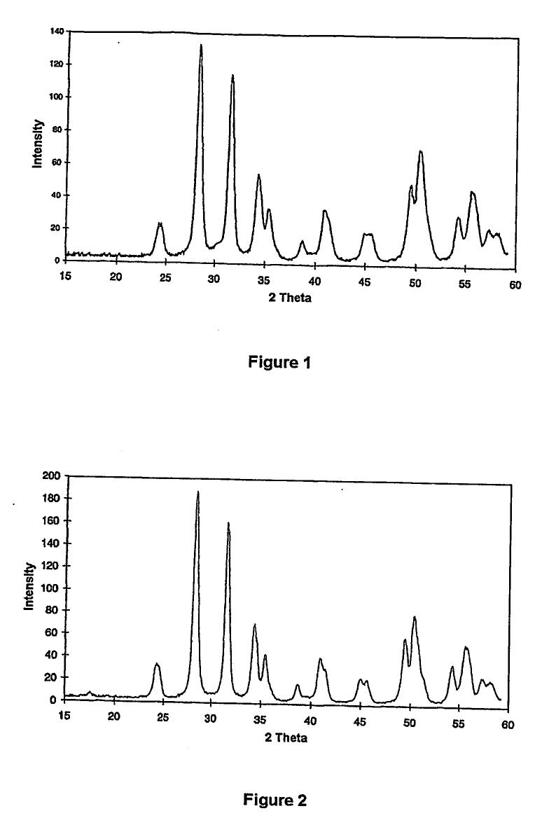

To produce the catalytically active material, 1 g of zirconium oxide (XZ16075) produced by Norton was provided as the initial support. The BET surface area in the untreated state is 46 m²/g. The majority of this support material was composed of the monoclinic form. The phase composition of the zirconium oxide is illustrated in the X-ray diffractogram shown in FIG. 1.

Following the calcining of the zirconium oxide at 700° C. for 16 h, the specific surface area is 31 m²/g; the phase composition is illustrated in the X-ray diffractogram shown in FIG. 2.

98 μl of an aqueous 1 molar Ru(NO₂) (NO₃) solution were diluted with 652 μl of water. The zirconium oxide was impregnated with the 750 μl of the resulting solution, which corresponded to the water uptake of the zirconium oxide. The ZrO₂ impregnated in this way was then dried for 16 hours at 80° C. The material was then calcined for 2 hours at 500° C. in air (referred to as “fresh”), and some of it was then additionally calcined for 16 hours at 700° C. in air (referred to as “aged”).

### Examples 2 to 23 (E2-E23)

The catalysts were produced as described in Example 1, with the zirconium oxide being impregnated with aqueous solution of Ru(NO₂) (NO₃) and further salts, such as platinum nitrate, rhodium nitrate, lanthanum nitrate and cerium nitrate). The table of examples (Table 1) gives the compositions of the corresponding catalysts, based on % by weight, with the molecular weights of the precious metals given in elemental form and those of the other metals given in oxidic form, for calculation purposes.

### Examples 24 to 41 (E23-E41)

A catalyst was produced by mechanically mixing two components, of which the first component comprised a ruthenium-containing ZrO₂ and the second component comprised an NOx storage catalyst with CeO₂ as support oxide.

The first component, with Ru as active metal and zirconium oxide as support oxide, was produced as in Examples 1 to 23.

To produce the second component, CeO₂ was impregnated with aqueous solution of one of the following salts, barium acetate, praseodymium nitrate, neodymium nitrate, terbium nitrate, europium nitrate, dysprosium nitrate, and was dried for 16 hours at 80° C. The compositions based on % by weight are compiled in Table 2.

Then, 0.5 g of the first component was mixed with 0.2 g of the second component, and the mixture was calcined for 2 hours at 500° C. in air (referred to as “fresh”), and then half of the mixture was additionally calcined in air for 16 hours at 700° C. (referred to as “aged”).

TABLE 1
Composition of the ruthenium-containing ZrO₂ catalysts

| | Sample | | Contents/% by | | | | |
|---|---|---|---|---|---|---|---|
| | designation | | weight | | | | |
| Example | fresh | aged | Ru | Pt | Rh | La | Ce |
| B1 | D1088 | D1089 | 1 | 0 | | | |
| B2 | D1090 | D1091 | 0.9 | 0.1 | | | |
| B3 | D1092 | D1093 | 0.8 | 0.2 | | | |
| B4 | D1094 | D1095 | 0.6 | 0.4 | | | |
| B5 | D1096 | D1097 | 0.4 | 0.6 | | | |
| B6 | D1098 | D1099 | 0.2 | 0.8 | | | |
| B7 | D1100 | D1101 | 0.1 | 0.9 | | | |
| B8 | D1104 | D1105 | 1 | 0 | | | 5 |
| B9 | D1106 | D1107 | 0.9 | 0.1 | | | 5 |
| B10 | D1108 | D1109 | 0.8 | 0.2 | | | 5 |
| B11 | D1110 | D1111 | 0.6 | 0.4 | | | 5 |
| B12 | D1112 | D1113 | 0.4 | 0.6 | | | 5 |
| B13 | D1114 | D1115 | 0.2 | 0.8 | | | 5 |
| B14 | D1116 | D1117 | 0.1 | 0.9 | | | 5 |
| B15 | D1422 | D1423 | 0.1 | 0.8 | 0.1 | | |
| B16 | D1426 | D1427 | 0.1 | 0 | 0.9 | | |
| B17 | D1430 | D1431 | 0.2 | 0 | 0.8 | | |
| B18 | D1438 | D1439 | 0.1 | 0.8 | 0.1 | 5 | |
| B19 | D1442 | D1443 | 0.1 | 0 | 0.9 | 5 | |
| B20 | D1446 | D1447 | 0.2 | 0 | 0.8 | 5 | |
| B21 | D1454 | D1455 | 0.1 | 0.8 | 0.1 | | 5 |
| B22 | D1458 | D1459 | 0.1 | 0 | 0.9 | | 5 |
| B23 | D1462 | D1463 | 0.2 | 0 | 0.8 | | 5 |

TABLE 2
Composition of the 2-component catalysts with ruthenium-containing ZrO2 catalysts as first component
and a NOx storage material as second component

| | | | Content/% by weight | | | | | | | | | | |
|---|---|---|---|---|---|---|---|---|---|---|---|---|---|
| | Sample | | Precious metal component | | | | | NOx storage component | | | | | |
| | designation | | with ZrO₂ as support oxide | | | | | with CeO₂ as support oxide | | | | | |
| Example | fresh | aged | Ru | Pt | Rh | La₂O₃ | CeO₂ | BaO | Pr₆O₁₁ | Nd₂O₃ | Tb₂O₃ | Eu₂O₃ | Dy₂O₃ |
| B24 | D1727 | D1728 | 0.1 | 0.8 | 0.1 | 0 | 0 | 15 | 0 | 0 | 0 | 0 | 0 |
| B25 | D1729 | D1730 | 0.1 | 0.8 | 0.1 | 0 | 0 | 0 | 15 | 0 | 0 | 0 | 0 |
| B26 | D1731 | D1732 | 0.1 | 0.8 | 0.1 | 0 | 0 | 0 | 0 | 15 | 0 | 0 | 0 |
| B27 | D1733 | D1734 | 0.1 | 0.8 | 0.1 | 0 | 0 | 0 | 0 | 0 | 15 | 0 | 0 |
| B28 | D1735 | D1736 | 0.1 | 0.8 | 0.1 | 0 | 0 | 0 | 0 | 0 | 0 | 15 | 0 |
| B29 | D1737 | D1738 | 0.1 | 0.8 | 0.1 | 5 | 0 | 15 | 0 | 0 | 0 | 0 | 0 |
| B30 | D1739 | D1740 | 0.1 | 0.8 | 0.1 | 5 | 0 | 0 | 15 | 0 | 0 | 0 | 0 |
| B31 | D1741 | D1742 | 0.1 | 0.8 | 0.1 | 5 | 0 | 0 | 0 | 15 | 0 | 0 | 0 |
| B32 | D1743 | D1744 | 0.1 | 0.8 | 0.1 | 5 | 0 | 0 | 0 | 0 | 15 | 0 | 0 |
| B33 | D1745 | D1746 | 0.1 | 0.8 | 0.1 | 5 | 0 | 0 | 0 | 0 | 0 | 15 | 0 |
| B34 | D1747 | D1748 | 0.1 | 0.8 | 0.1 | 0 | 5 | 15 | 0 | 0 | 0 | 0 | 0 |
| B35 | D1749 | D1750 | 0.1 | 0.8 | 0.1 | 0 | 5 | 0 | 15 | 0 | 0 | 0 | 0 |
| B36 | D1751 | D1752 | 0.1 | 0.8 | 0.1 | 0 | 5 | 0 | 0 | 15 | 0 | 0 | 0 |
| B37 | D1753 | D1754 | 0.1 | 0.8 | 0.1 | 0 | 5 | 0 | 0 | 0 | 15 | 0 | 0 |
| B38 | D1755 | D1756 | 0.1 | 0.8 | 0.1 | 0 | 5 | 0 | 0 | 0 | 0 | 15 | 0 |
| B39 | D1757 | D1758 | 0.1 | 0.8 | 0.1 | 0 | 0 | 0 | 0 | 0 | 0 | 0 | 15 |
| B40 | D1759 | D1760 | 0.1 | 0.8 | 0.1 | 5 | 0 | 0 | 0 | 0 | 0 | 0 | 15 |
| B41 | D1761 | D1762 | 0.1 | 0.8 | 0.1 | 0 | 5 | 0 | 0 | 0 | 0 | 0 | 15 |

### Comparative Example (CE)

A comparative example relates to a commercially available NOₓ storage catalyst based on Pt/Ba/Ce with 130 g of EM/ft³ (reference catalyst).

Catalyst Testing

Activity measurements were carried out in fixed-bed laboratory reactors made from stainless steel under simulated lean exhaust gas. The catalysts were tested in cyclical rich/lean mode (2 s rich/80 s lean) and in continuous operation with excess oxygen.

| | |
|---|---|
| Temperature range: | 150-450° C. |
| Gas mixture composition: | |
| Lean: | 1000 vppm CO, |
| | 100 vppm Propene, |
| | 300 vppm NO, 5% O₂, |
| | 5% H₂O, Remainder-N₂. |
| Rich: | 0.03% O₂, ˜6% CO, |
| | ˜2% H₂ |
| Gas throughput: | 451/h |
| m_{cat}. | 0.25 g (B1-B23); |
| | 0.35 g (B24-B41); |
| | 0.65 g |
| (Reference) | |
| Precious metal mass in the | 0.0025 g |
| catalyst used for testing: | |

The comparison measurement between the new catalysts and the reference catalysts are based on identical quantities of precious metals.

To evaluate the catalysts, the mean NOₓ conversions within the first 45 sec of the lean-burn phase immediately following a richer phase and the mean NOₓ conversions within three complete rich/lean cycles were determined. Furthermore, the T₅₀ values (temperature at which 50% conversion is reached) for the CO oxidation were used to evaluate the oxidation activity.

The results of the catalytic tests are compiled in Tables 3 to 6. It is apparent from these tests that the novel catalysts, after thermal ageing in particular in the temperature range of 200-300° C. which is of importance in particular for diesel applications, allow significantly higher NOₓ conversion rates to be achieved than the reference catalyst.

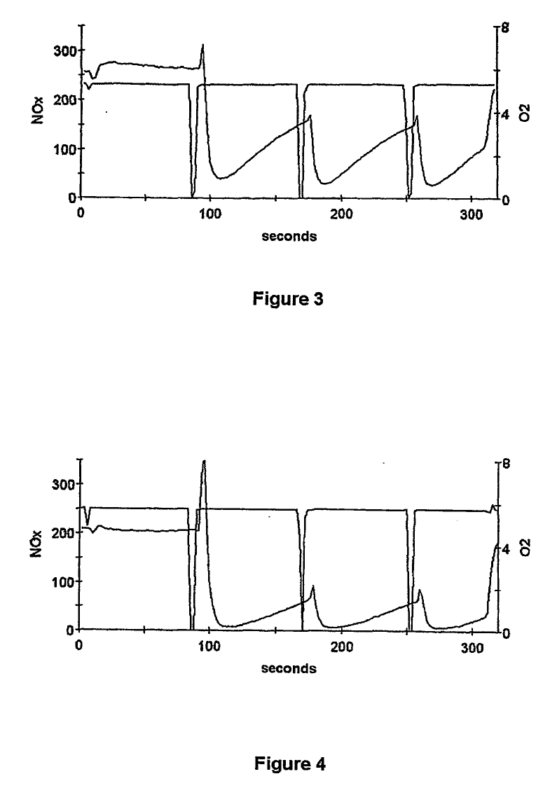

The results are illustrated in graph form in FIGS. 3 to 5, FIG. 3 showing the curve of the NOx conversion over time for the D1115 sample at 250° C. (aged, E13).

FIG. 4 shows the curve for the NOx conversion over time for the D1455 sample at 250° C. (aged, E21).

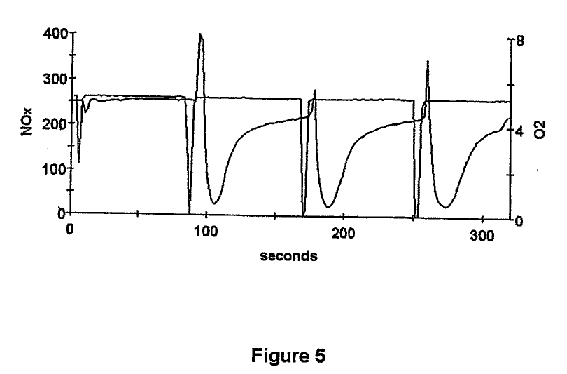

FIG. 5 shows the curve for the NOₓ conversion over time for the aged reference samples at 205° C. (CE).

TABLE 3
Results of the catalytic tests on NOₓ conversion in rich/lean mode

| | Mean NOₓ conversion | | | | | |
|---|---|---|---|---|---|---|
| | in the lean-burn phase within 45 sec/% | | | | | |
| | 200° C. | 200° C. | 250 C. | 250° C. | 300° C. | 300° C. |
| Example | fresh | aged | fresh | aged | fresh | aged |
| B1 | 5 | 11 | 49 | 53 | 72 | 68 |
| B2 | 10 | 10 | 69 | 54 | 83 | 76 |
| B3 | 13 | 11 | 71 | 55 | 81 | 73 |
| B4 | 16 | 6 | 73 | 49 | 81 | 74 |
| B5 | 18 | 4 | 73 | 48 | 81 | 72 |
| B6 | 21 | 6 | 55 | 43 | 68 | 66 |
| B7 | 21 | 4 | 48 | 30 | 58 | 56 |
| B8 | 39 | 34 | 65 | 62 | 72 | 69 |
| B9 | 68 | 49 | 77 | 69 | 79 | 75 |
| B10 | 64 | 61 | 79 | 75 | 81 | 77 |
| B11 | 63 | 58 | 78 | 73 | 80 | 78 |
| B12 | 55 | 58 | 75 | 72 | 76 | 74 |
| B13 | 58 | 55 | 75 | 77 | 79 | 81 |
| B14 | 54 | 57 | 69 | 78 | 74 | 81 |
| B15 | 34 | 3 | 66 | 28 | 78 | 70 |
| B16 | 27 | 26 | 59 | 39 | 79 | 58 |
| B17 | 13 | 23 | 56 | 47 | 77 | 64 |
| B18 | 9 | 0 | 42 | 25 | 85 | 80 |
| B19 | 7 | 28 | 60 | 61 | 84 | 81 |
| B20 | 0 | 18 | 48 | 58 | 74 | 77 |
| B21 | 48 | 27 | 71 | 76 | 72 | 80 |
| B22 | 50 | 24 | 69 | 60 | 79 | 76 |
| B23 | 51 | 15 | 71 | 64 | 79 | 76 |
| B24 | 46 | 8 | 57 | 29 | 65 | 61 |
| B25 | 44 | 8 | 59 | 29 | 60 | 59 |
| B26 | 45 | 10 | 62 | 30 | 65 | 62 |
| B27 | 46 | 15 | 65 | 79 | 66 | 79 |
| B28 | 43 | 11 | 59 | 81 | 68 | 78 |
| B29 | 30 | 0 | 68 | 78 | 74 | 76 |
| B30 | 33 | 0 | 74 | 76 | 74 | 76 |
| B31 | 0 | 0 | 21 | 93 | 71 | 77 |
| B32 | 2 | 0 | 23 | 17 | 67 | 66 |
| B33 | 4 | 0 | 32 | 11 | 81 | 83 |
| B34 | 13 | 22 | 37 | 68 | 64 | 74 |
| B35 | 23 | 30 | 57 | 69 | 62 | 71 |
| B36 | 26 | 27 | 57 | 69 | 62 | 73 |
| B37 | 21 | 32 | 58 | 70 | 67 | 75 |
| B38 | 21 | 26 | 51 | 69 | 65 | 76 |
| B39 | 34 | 10 | 65 | 35 | 74 | 68 |
| B40 | 0 | 0 | 21 | 19 | 74 | 78 |
| B41 | 22 | 20 | 52 | 57 | 64 | 65 |
| VB | 63 | 24 | 87 | 48 | 90 | 67 |

TABLE 4
NOₓ conversion at the fresh catalysts in 3 rich/lean cycles

| | Sample | Mean NOx conversion | | | |
|---|---|---|---|---|---|
| | designation | in 3 rich/lean cycles/% | | | |
| Example | fresh | 200° C. | 250° C. | 300° C. | 400° C. |
| B1 | D1088 | 1 | 31 | 51 | 33 |
| B2 | D1090 | 5 | 57 | 71 | 41 |
| B3 | D1092 | 6 | 60 | 69 | 38 |
| B4 | D1094 | 8 | 63 | 70 | 35 |
| B5 | D1096 | 8 | 61 | 69 | 35 |
| B6 | D1098 | 11 | 43 | 54 | 30 |
| B7 | D1100 | 7 | 30 | 44 | 33 |
| B8 | D1104 | 23 | 48 | 55 | 38 |
| B9 | D1106 | 46 | 62 | 67 | 43 |
| B10 | D1108 | 39 | 64 | 69 | 45 |
| B11 | D1110 | 37 | 64 | 67 | 42 |
| B12 | D1112 | 30 | 60 | 63 | 41 |
| B13 | D1114 | 36 | 60 | 66 | 40 |
| B14 | D1116 | 34 | 55 | 61 | 39 |
| B15 | D1422 | 27 | 55 | 66 | 39 |
| B16 | D1426 | 18 | 47 | 65 | 47 |
| B17 | D1430 | 10 | 45 | 64 | 42 |
| B18 | D1438 | 6 | 36 | 76 | 69 |
| B19 | D1442 | 6 | 45 | 68 | 64 |
| B20 | D1446 | 1 | 33 | 58 | 63 |
| B21 | D1454 | 22 | 54 | 63 | 40 |
| B22 | D1458 | 32 | 54 | 64 | 36 |
| B23 | D1462 | 34 | 53 | 65 | 39 |
| B24 | D1727 | 32 | 46 | 50 | 33 |
| B25 | D1729 | 31 | 44 | 45 | 32 |
| B26 | D1731 | 30 | 48 | 51 | 28 |
| B27 | D1733 | 33 | 51 | 51 | 33 |
| B28 | D1735 | 28 | 46 | 53 | 33 |
| B29 | D1737 | 14 | 53 | 60 | 54 |
| B30 | D1739 | 20 | 60 | 61 | 60 |
| B31 | D1741 | 0 | 13 | 53 | 50 |
| B32 | D1743 | 0 | 16 | 61 | 59 |
| B33 | D1745 | 0 | 22 | 66 | 56 |
| B34 | D1747 | 6 | 20 | 49 | 32 |
| B35 | D1749 | 11 | 33 | 48 | 36 |
| B36 | D1751 | 12 | 32 | 48 | 31 |
| B37 | D1753 | 10 | 33 | 52 | 34 |
| B38 | D1755 | 8 | 27 | 52 | 33 |
| B39 | D1757 | 20 | 14 | 59 | 33 |
| B40 | D1759 | 0 | 31 | 56 | 55 |
| B41 | D1761 | 9 | 17 | 51 | 31 |
| VB | Reference | 52 | 79 | 84 | 85 |

TABLE 5
NOₓ conversion at the aged catalysts in 3 rich/lean cycles

| | Sample | Mean NOx conversion | | | |
|---|---|---|---|---|---|
| | designation | in 3 rich/lean cycles/% | | | |
| Example | aged | 200° C. | 250° C. | 300° C. | 400° C. |
| B1 | D1089 | 5 | 38 | 53 | 37 |
| B2 | D1091 | 4 | 39 | 59 | 37 |
| B3 | D1093 | 4 | 41 | 58 | 35 |
| B4 | D1095 | 2 | 35 | 60 | 34 |
| B5 | D1097 | 2 | 33 | 56 | 33 |
| B6 | D1099 | 4 | 29 | 51 | 29 |
| B7 | D1101 | 0 | 19 | 42 | 26 |
| B8 | D1105 | 15 | 43 | 54 | 37 |
| B9 | D1107 | 28 | 53 | 62 | 40 |
| B10 | D1109 | 37 | 58 | 63 | 39 |
| B11 | D1111 | 29 | 55 | 64 | 40 |
| B12 | D1113 | 33 | 54 | 61 | 37 |
| B13 | D1115 | 35 | 61 | 68 | 42 |
| B14 | D1117 | 36 | 63 | 68 | 36 |
| B15 | D1423 | 1 | 21 | 56 | 47 |
| B16 | D1427 | 7 | 19 | 38 | 38 |
| B17 | D1431 | 3 | 23 | 43 | 36 |
| B18 | D1439 | 0 | 21 | 71 | 73 |
| B19 | D1443 | 9 | 41 | 61 | 58 |
| B20 | D1447 | 4 | 37 | 59 | 57 |
| B21 | D1455 | 21 | 57 | 68 | 52 |
| B22 | D1459 | 5 | 40 | 59 | 33 |
| B23 | D1463 | 6 | 44 | 61 | 33 |
| B24 | D1728 | 4 | 17 | 42 | 27 |
| B25 | D1730 | 3 | 17 | 43 | 28 |
| B26 | D1732 | 3 | 19 | 46 | 30 |
| B27 | D1734 | 12 | 27 | 50 | 32 |
| B28 | D1736 | 8 | 31 | 57 | 34 |
| B29 | D1738 | 0 | 21 | 64 | 55 |
| B30 | D1740 | 0 | 23 | 67 | 56 |
| B31 | D1742 | 0 | 24 | 69 | 57 |
| B32 | D1744 | 0 | 11 | 42 | 57 |
| B33 | D1746 | 0 | 18 | 71 | 62 |
| B34 | D1748 | 20 | 52 | 62 | 38 |
| B35 | D1750 | 21 | 50 | 59 | 35 |
| B36 | D1752 | 17 | 49 | 61 | 39 |
| B37 | D1754 | 19 | 46 | 59 | 34 |
| B38 | D1756 | 17 | 46 | 61 | 39 |
| B39 | D1758 | 8 | 29 | 59 | 36 |
| B40 | D1760 | 0 | 17 | 62 | 54 |
| B41 | D1762 | 19 | 34 | 54 | 33 |
| VB | Reference | 19 | 41 | 57 | 73 |

TABLE 6
Results of the catalytic tests on CO oxidation

T50 values
[° C.]

| Example | fresh | aged |
|---|---|---|
| B1 | 212 | 206 |
| B2 | 212 | 207 |
| B3 | 193 | 206 |
| B4 | 183 | 206 |
| B5 | 194 | 206 |
| B6 | 184 | 205 |
| B7 | 174 | 215 |
| B8 | 180 | 186 |
| B9 | 180 | 164 |
| B10 | 171 | 163 |
| B11 | 170 | 163 |
| B12 | 181 | 164 |
| B13 | 171 | 171 |
| B14 | 171 | 162 |
| B15 | 156 | 197 |
| B16 | 187 | 224 |
| B17 | 194 | 225 |
| B18 | 196 | 268 |
| B19 | 215 | 215 |
| B20 | 215 | 225 |
| B21 | 187 | 197 |
| B22 | 156 | 195 |
| B23 | 165 | 195 |
| B24 | <200 | 180 |
| B25 | <200 | 179 |
| B26 | <200 | 181 |
| B27 | <200 | 174 |
| B28 | <200 | 176 |
| B29 | <200 | 248 |
| B30 | <200 | 248 |
| B31 | 248 | 237 |
| B32 | 218 | 261 |
| B33 | 190 | 264 |
| B34 | 185 | 197 |
| B35 | 186 | 185 |
| B36 | 182 | 189 |
| B37 | 189 | 185 |
| B38 | 191 | 201 |
| B39 | 160 | 179 |
| B40 | 235 | 262 |
| B41 | 186 | 201 |
| VB | 153 | 159 |

Key to figures:
B1 = Example 1, etc.
VB = Comparative example

1.-21. (canceled)

22. A catalyst for exhaust-gas purification in lean-burn engines, the catalyst comprising:
(i) ZrO₂ and/or Ce/Zr mixed oxide as support material, and
(ii) ruthenium as active metal, on its own or together with at least one further active metal selected from the precious metals group.

23. A catalyst according to claim 22 further comprising at least one rare earth oxide as a promoter.

24. A catalyst according to claim 23 further comprising at least one further transition metal or a further transition metal compound as co-promoter, the transition metal being different from rare earths and precious metals.

25. A catalyst according to claim 24 wherein the ruthenium and, if present, the rare earth oxide are jointly present on the ZrO₂ and/or Ce/Zr mixed oxide.

26. A catalyst according to claim 25 wherein the rare earth oxide and/or the transition metal/transition metal compound and/or the at least one further active metal are likewise at least partially present on the ZrO₂.

27. A catalyst according to claim 22 wherein the further active metal is selected from Pt, Rh, Pd, Re, Os and Ir.

28. A catalyst according to claim 22 wherein the proportion of the sum of ruthenium and all further active metals used relative to the total quantity of ZrO₂ used is from 0.1% by weight to 5% by weight.

29. A catalyst according to claim 22 wherein more than 80% of the zirconium oxide used corresponds to the monoclinic phase.

30. A catalyst according to claim 23 wherein the at least one rare earth oxide is selected from the following group consisting of La oxide, Ce oxide, Pr oxide, Nd oxide, Sm oxide, Eu oxide, Gd oxide, Tb oxide, Dy oxide, Ho oxide, Er oxide, Tm oxide, Yb oxide, Lu oxide, and mixtures or mixed oxides of at least two of the abovementioned oxides.

31. A catalyst according to claim 23 wherein the proportion of the rare earth oxides relative to the total quantity of ZrO₂ is from 2% by weight to 30% by weight.

32. A catalyst according to claim 22 further comprising a NOx storage component.

33. A catalyst according to claim 23 wherein the NOx storage component is selected from the group consisting of oxides or carbonates of Ba, Sr, La oxide, Pr oxide, Nd oxide, Sm oxide, Eu oxide, Gd oxide, Tb oxide, Dy oxide, Ho oxide, Er oxide, Tm oxide, Yb oxide, Lu oxide, on a porous support oxide.

34. A catalyst according to claim 33 wherein the porous support oxide is selected from Al₂O₃, SiO₂, Al₂O₃/SiO₂ mixed oxide, TiO₂, CeO₂ and Ce/Zr mixed oxide.

35. A catalyst according to claim 1, in the form of powder, granules, extrudate, a shaped body or a coated honeycomb body.

36. A method for purifying the exhaust gas from lean-burn engines in the rich/lean and constant lean mode, wherein a catalyst according to claim 1 is used.

37. A method according to claim 36 wherein the rich/lean mode is realized in alternating rich and lean cycles, with the ratio of the duration of lean cycles to the duration of rich cycles, in normal driving mode, being at least 10:1, and the absolute duration of a lean cycle in normal driving mode being from 10 seconds to 180 seconds.

38. A method according to claim 36 wherein the exhaust-gas purification comprises the simultaneous oxidation of hydrocarbons and carbon monoxide and the reduction of nitrogen oxides, and optionally also, in the case of diesel engines, the removal of particulates.

39. A method according to claim 36 wherein the lean-burn engine is selected from the group consisting of spark-ignition engines with direct petrol injection, hybrid engines, diesel engines, multi-fuel engines, stratified charge engines and spark-ignition engines with unthrottled part-load operation and higher compression or with unthrottled part-load operation or higher compression, each with direct injection.

40. A method according to claim 36 wherein the catalyst is installed in a position close to the engine or in an underfloor position.

41. A method according to claim 37 wherein a NOx sensor is used to control the rich/lean cycle, and a richer phase is induced precisely when a predetermined NOₓ limit value is exceeded.

42. A method according to claim 36 wherein the catalyst according to claim 1 is used in any desired combination with at least one of the catalysts or filters selected from the following group: starting catalyst, HC-SCR catalyst, NOx storage catalyst, λ-controlled three-way catalyst, particulate filter, soot filter.
